(19) United States
(12) Patent Application Publication
(10) Pub. No.: US 2016/0096499 A1
(43) Pub. Date: Apr. 7, 2016

(54) PASSENGER STATE ESTIMATION SYSTEM AND IN-VEHICLE APPARATUS

(71) Applicant: TOYOTA JIDOSHA KABUSHIKI KAISHA, Toyota-shi (JP)

(72) Inventor: Masashi NANAO, Toyota-shi (JP)

(21) Appl. No.: 14/829,918

(22) Filed: Aug. 19, 2015

(30) Foreign Application Priority Data
Oct. 1, 2014 (JP) 2014-203354

(51) Int. Cl. B60R 21/015; G07C 5/08; B60R 21/0136; G07C 5/00

(52) U.S. Cl. CPC B60R 21/01512; G07C 5/008; G07C 5/0808; G07C 5/085; B60R 21/0136; B60R 2021/0027

(57) ABSTRACT

A passenger state estimation system includes an in-vehicle apparatus including a crash determination unit to determine whether a crash has occurred to a vehicle, a recording execution unit configured to have an in-vehicle recording medium record data of the crash, and a transmitter unit to transmit the data; and a center including a receiver unit to receive the data transmitted from the transmitter unit of the vehicle, and a passenger estimation unit to estimate a state of the vehicle passenger(s), based on the received data. If the crash is a crash requiring airbag deployment, and another crash not requiring airbag deployment has occurred prior to the crash, the transmitter unit transmits the data of both crashes to the center. The passenger estimation unit estimates the state of the vehicle passenger(s), based on the data of both crashes.

### FIELD

The disclosures herein generally relate to a passenger state estimation system and an in-vehicle apparatus, especially, a passenger state estimation system and an in-vehicle apparatus that are suitable for transmitting information from the vehicle to a center, detected when a vehicle crashes, and for estimating a state of the vehicle passenger(s) at the center.

### BACKGROUND

Conventionally, a system has been known that detects a load on the body of a passenger due to a crash accident of a vehicle, and sends a report about the load (see, for example, Patent Document 1). This system includes an in-vehicle apparatus and a center. The in-vehicle apparatus detects an occurrence of a crash accident of the vehicle, collects data about the vehicle behavior or passenger behavior from the beginning to end of the crash, and sends a report to the center. In response to receiving the report from the in-vehicle apparatus of the vehicle, the center contacts a rescue agency for emergency services or doctors, depending on an estimated state of the passenger(s).

### RELATED-ART DOCUMENTS

### Patent Documents

[Patent Document 1] Japanese Laid-open Patent Publication No. 2002-127857

However, if multiple crashes occur simultaneously, which tends to occur especially around a location on a freeway, a single vehicle may be damaged by multiple crashes. In such an occurrence of multiple crashes, the state of the passenger(s) on the vehicle can become drastically worse than when the vehicle is damaged by only one crash. Therefore, by just sending information about one crash from the beginning to end to a center, as in the above system, a state estimation of the passenger(s) is limited to the one crash, and the precision of the state estimation may be reduced.

In view of the above, the present invention has an object to provide a passenger state estimation system and an in-vehicle apparatus that can improve the precision of the state estimation of a passenger(s) when crashes occur to a vehicle.

### SUMMARY

According to an embodiment of the present invention, a passenger state estimation system includes an in-vehicle apparatus configured to include a crash determination unit configured to determine whether a crash has occurred to a vehicle having the in-vehicle apparatus installed, by using an in-vehicle sensor, a recording execution unit configured, if the crash determination unit determines that a crash has occurred to the vehicle, to have an in-vehicle recording medium record data of at least one of passenger information, vehicle operation information, and a degree of the crash, the data having been generated when the crash occurs, and a transmitter unit configured to transmit the data externally; and a center configured to include a receiver unit configured to receive the data transmitted from the transmitter unit of the vehicle, and a passenger estimation unit configured to estimate a state of a passenger(s) of the vehicle, based on the data received by the receiver unit. If the crash determined to have occurred to the vehicle by the crash determination unit is a crash requiring airbag deployment, and crashes including a crash not requiring airbag deployment have been determined to have occurred prior to the crash requiring airbag deployment within a predetermined time period, by the crash determination unit, the transmitter unit transmits the data generated when the crash requiring airbag deployment has occurred, and the data generated when the crashes including the crash not requiring airbag deployment have occurred, to the center. The passenger estimation unit estimates the state of the passenger of the vehicle, based on the data generated when the crash requiring airbag deployment has occurred, and the data generated when the crashes including the crash not requiring airbag deployment have occurred.

Also, according to another embodiment of the present invention, an in-vehicle apparatus includes a crash determination unit configured to determine whether a crash has occurred to a vehicle having the in-vehicle apparatus installed, by using an in-vehicle sensor; a recording execution unit configured, if the crash determination unit determines that a crash has occurred to the vehicle, to have an in-vehicle recording medium record data of at least one of passenger information, vehicle operation information, and a degree of the crash, the data having been generated when the crash occurs; and a transmitter unit configured to transmit the data to a center. If the crash determined to have occurred to the vehicle by the crash determination unit is a crash requiring airbag deployment, and crashes including a crash not requiring airbag deployment have been determined to have occurred prior to the crash requiring airbag deployment within a predetermined time period, by the crash determination unit, the transmitter unit transmits the data generated when the crash requiring airbag deployment has occurred, and the data generated when the crashes including the crash not requiring airbag deployment have occurred, to the center.

According to at least one embodiment of the present invention, when the vehicle crashes, it is possible to improve the precision of the state estimation of a passenger(s) when crashes occur to a vehicle.

### BRIEF DESCRIPTION OF DRAWINGS

FIG. 1 is a configuration diagram of a passenger state estimation system according to an embodiment of the present invention; and

FIG. 2 is a flowchart of an example a control routine that is executed in the passenger state estimation system according to the present embodiment.

### DESCRIPTION OF EMBODIMENTS

In the following, specific embodiments of a passenger state estimation system and an in-vehicle apparatus relating to the present invention will be described with reference to the drawings.

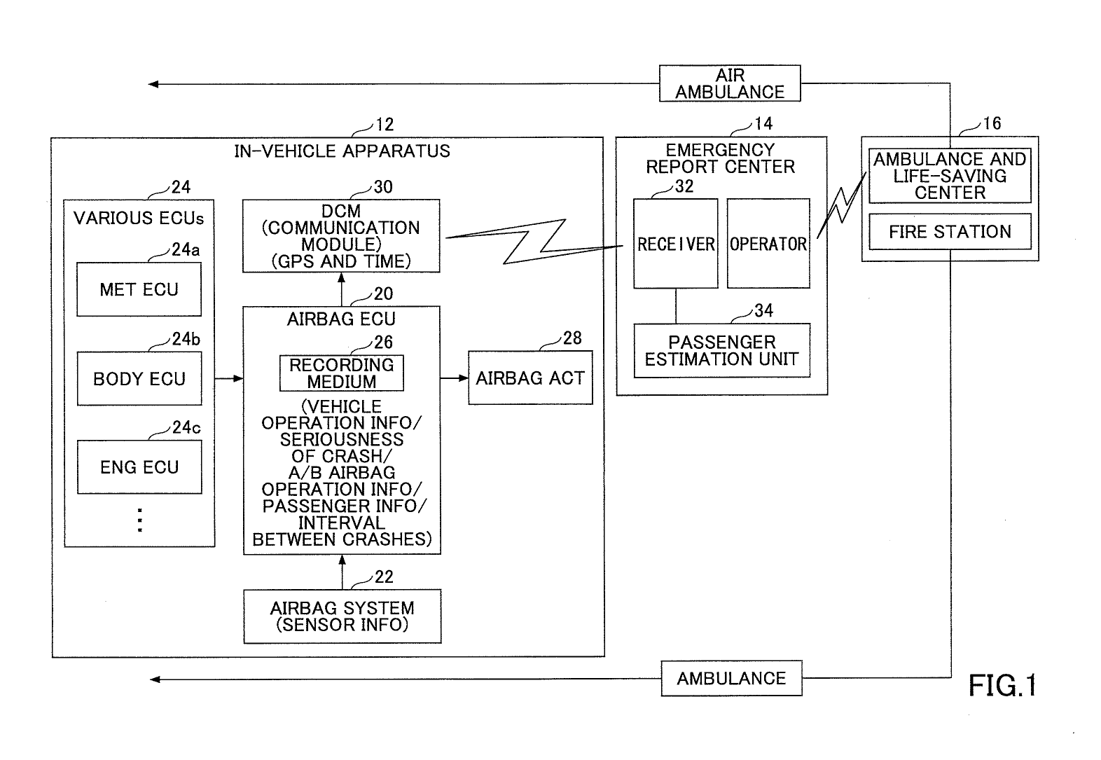

FIG. 1 illustrates a configuration diagram of a passenger state estimation system 10 according to an embodiment of the present invention. The passenger state estimation system 10 in the present embodiment is a system that, when a crash has occurred to a vehicle, sends information of various sensors from the vehicle to a center, to have the center estimate a state about seriousness of injury of a vehicle passenger(s).

As shown in FIG. 1, the passenger state estimation system 10 includes an in-vehicle apparatus 12, an emergency report center 14, and emergency services 16. The in-vehicle apparatus 12 is an apparatus that is installed in a vehicle. The in-vehicle apparatus 12 determines whether a crash has occurred to the vehicle having the in-vehicle apparatus 12 installed, and if determining that a crash has occurred to the vehicle, collects information from various sensors. Also, if determining that a serious crash has occurred to the vehicle where a degree of the crash is greater than or equal to a predetermined level, the in-vehicle apparatus 12 further transmits the collected sensor information to the emergency report center 14 as an emergency report.

In response to receiving the emergency report from the in-vehicle apparatus 12 of the vehicle, the emergency report center 14 estimates the state of a passenger(s) of the vehicle based on the sensor information, and if necessary, sends a report about the occurrence of the traffic accident of the vehicle to one of the emergency services 16. An emergency service 16 is an agency such as an ambulance and life-saving center, a fire department, a hospital, or a police department, that receives the report from the emergency report center 14, to take necessary measures to rescue the passenger(s) of the vehicle in the traffic accident.

The in-vehicle apparatus 12 includes an airbag ECU 20 that is mainly configured with a microcomputer. The airbag ECU 20 is connected with sensors 22, and also connected with a group of ECUs 24. The sensors 22 include various sensors that are necessary for determining whether a crash has occurred to the vehicle, and for determining whether to deploy the airbags of respective seats. Also, the group of ECUs 24 are ECUs that include respective electronic control units mainly configured with various microcomputers that are necessary for detecting various types of information about the vehicle and the passenger(s) when a crash occurs.

The sensors 22 are, for example, an acceleration sensor on the floor of the vehicle compartment to detect acceleration generated in a forward or backward direction, an acceleration sensor on the floor of the vehicle compartment to detect acceleration generated in a leftward or rightward direction, and a satellite sensor to detect acceleration which is disposed on a front part of the vehicle (such as a bumper). Also, the group of ECUs 24 are, for example, a meter ECU 24a, a body ECU 24b, and an engine ECU 24c, and the like, which are apparatuses that can output data representing vehicle behavior such as speed, acceleration, steering angle, brake pedal operation of the vehicle, etc.; data representing vehicle states such as whether the seats have passengers, and whether the passengers are buckled up; and data representing the passengers such as heart rates, blood pressures, captured facial images of the vehicle passengers, and the number of passengers.

The output data of the sensors 22 and the output data of the group of ECUs 24 are supplied to the airbag ECU 20. Based on the data supplied from the sensors 22, the airbag ECU 20 determines whether a crash has occurred to the vehicle, with an obstacle such as another vehicle. Note that forms of crashes include a front crash where a front part of the vehicle crashes into an obstacle; a rear crash where a rear part of the vehicle crashes into an obstacle; a side crash where a side part of the vehicle crashes into an obstacle; and a roll over where the vehicle turns over sideways. Also, determining whether a crash has occurred to the vehicle may be executed, for example, based on whether an acceleration value based on the data from the sensors 22 is greater than or equal to a predetermined value, or may be executed for the respective forms of crashes described above.

The airbag ECU 20 includes a recording medium 26 that can store data. When determining that a crash has occurred to the vehicle, the airbag ECU 20 has the recording medium 26 record data representing the vehicle behavior supplied from the sensors 22 and the group of ECUs 24 when the crash has occurred; data obtained by applying predetermined calculations to the supplied data; and the occurrence time of the crash having associated with the data.

Note that the data is recorded onto the recording medium 26 every time it is determined that a crash has occurred to the vehicle, regardless of the seriousness of the crash of the vehicle. Also, the data to be recorded onto the recording medium 26 specifically includes that represents the intensity of the crash (a degree of the crash); that represents whether an airbag has been deployed; operational information of the vehicle; passenger information; and time intervals between crashes if two or more crashes have occurred. Furthermore, the data to be recorded onto the recording medium 26 may include data about the vehicle passengers such as age, gender, and body-type that have been detected in advance or when the ignition has been turned on.

If determining that a crash has occurred to the vehicle, the airbag ECU 20 further determines whether the crash is serious enough to deploy an airbag. Note that this determination may be executed based on whether the degree of the crash of the vehicle is greater than or equal to a predetermined level for deploying an airbag, or more specifically, based on whether a temporal change of acceleration generated to the vehicle coincides with a predetermined pattern condition. Then, if determining that the degree of the crash of the vehicle is greater than or equal to the predetermined level for deploying an airbag, the airbag ECU 20 determines that it is a serious crash requiring airbag deployment, and determines that it is necessary to deploy the airbag.

The airbag ECU 20 is connected with the airbag actuator 28 that deploys the airbag. If determining that it is a serious crash requiring airbag deployment, the airbag ECU 20 gives an operational command to the airbag actuator 28. Following the operational command from the airbag ECU 20, the airbag actuator 28 deploys the airbag. The airbag having been deployed in this way protects the vehicle passenger.

The in-vehicle apparatus 12 also includes a DCM (Data Communication Module) 30 that is connected with the airbag ECU 20. The DCM 30 is a communication module for having the in-vehicle apparatus 12 connected with the emergency report center 14 for communication. If determining that a serious crash requiring airbag deployment has occurred to the vehicle, the airbag ECU 20 sends a report about the occurrence of the crash to the emergency report center 14, by automatically transmitting data collected on the recording medium 26 to the emergency report center 14 via the DCM 30. When transmitting the data to the emergency report center 14 from the airbag ECU 20, the DCM 30 appends positional information and time information of the vehicle to the data.

Also, the emergency report center 14 includes a receiver 32 mainly configured with a microcomputer, to receive a report and data from the in-vehicle apparatus 12, and a passenger estimation unit 34 to estimate the state of injury of a vehicle passenger(s). If receiving a report from the in-vehicle apparatus 12 by the receiver 32, the passenger estimation unit 34 estimates the state of the vehicle passenger, based on the data in the report obtained when the crash has occurred. Having estimated the state of the vehicle passenger(s) by the passenger estimation unit 34, and depending on the estimated result, the emergency report center 14 selects an emergency service 16, and automatically sends a report about the occurrence of the traffic accident of the vehicle to the selected emergency service 16.

Note that having estimated the state of the vehicle passenger(s) by the passenger estimation unit 34, the emergency report center 14 may display the estimated result on a screen or the like for an operator (a person). After having received the emergency report, the operator may make a phone call to the vehicle of the traffic accident, and based on the result, may manually send a report to the emergency service 16.

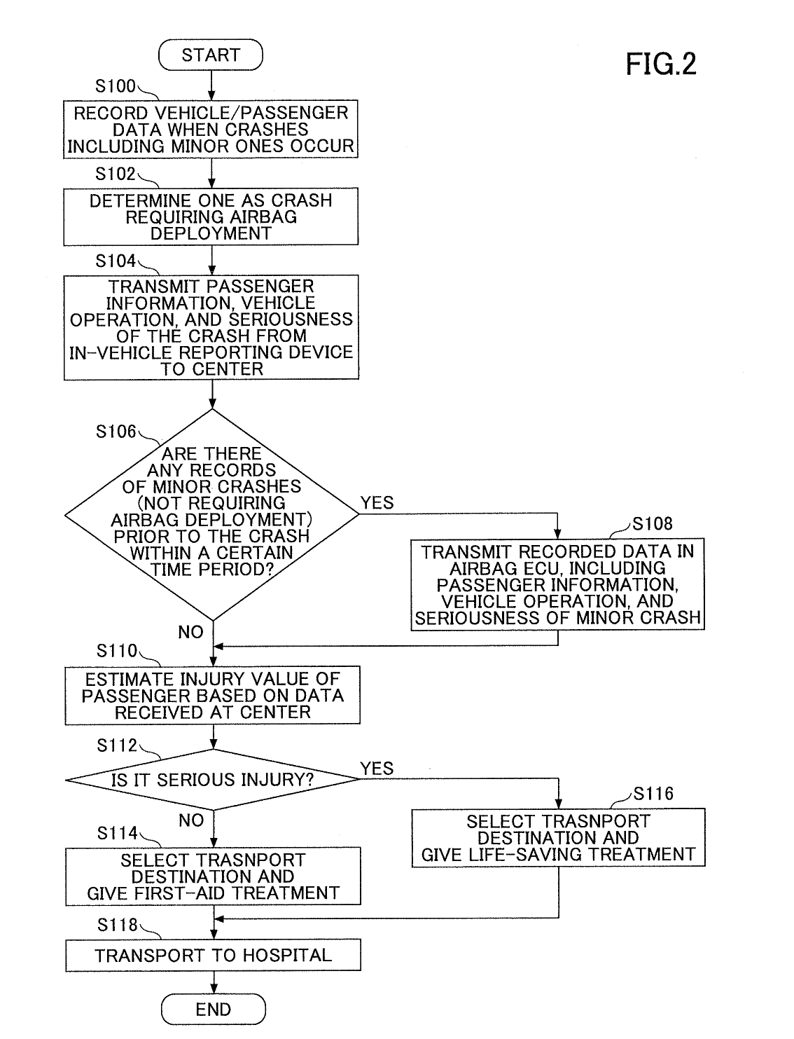

Next, with reference to FIG. 2, operations of the passenger state estimation system 10 in the present embodiment will be described. FIG. 2 illustrates a flowchart of an example of a control routine that is executed in the passenger state estimation system 10 according to the present embodiment.

In the passenger state estimation system 10 in the present embodiment, the airbag ECU 20 of the in-vehicle apparatus 12 determines whether a crash has occurred to the vehicle with an obstacle, which ranges from a minor crash to a serious crash, every predetermined interval (for example, every 0.5 ms or 1 ms) during an ignition-on state, based on data from the sensors 22. Also, in an ignition-on state, the airbag ECU 20 regularly transmits data generated in a predetermined format, to the emergency report center 14 via the DCM 30 every predetermined interval (for example, every 1 s or 5 s). Note that the data to be regularly transmitted is set to have a fixed value, for example, consecutive 0 s, before completing data generation on airbag deployment.

If determining that a crash has occurred to the vehicle with an obstacle, which ranges from a minor crash to a serious crash, the airbag ECU 20 has the recording medium 26 record data representing the vehicle behavior supplied from the sensors 22 and the group of ECUs 24 when the crash has occurred; data obtained by applying predetermined calculations to the supplied data; and the occurrence time of the crash having associated with the data (Step S100).

If determining that a crash has occurred to the vehicle as described above, the airbag ECU 20 further determines whether the crash is serious enough to deploy an airbag. Consequently, if determining that a serious crash has occurred (Step S102), to send a report to the emergency report center 14 that the serious crash (crash requiring airbag deployment) has occurred, the airbag ECU 20 automatically transmits the data about the passenger information, the vehicle operation information, and the degree of the crash, which have been collected on the recording medium 26 in the predetermined format when the serious crash has occurred, to the emergency report center 14 via the DCM 30 (Step S104).

If determining that a serious crash has occurred as described above, the airbag ECU 20 also determines whether any minor crashes have occurred prior to the occurrence of the serious crash within a predetermined time period (Step S106). Note that the predetermined time is a maximum value of a time interval during which multiple crashes could happen on a vehicle when multiple crashes occur, which has been empirically determined in advance, and set to, for example, five seconds. Also, the determination is executed based on whether there are any records of minor crashes not requiring airbag deployment on the recording medium 26, and a comparison result of the occurrence times between the current serious crash requiring airbag deployment, and the previous minor crashes not requiring airbag deployment, which are recorded on the recording medium 26.

If determining that no minor crashes have occurred prior to the occurrence of the serious crash within the predetermined time period, the airbag ECU 20 transmits no data other than the data generated with the serious crash to the emergency report center 14. On the other hand, if determining that a minor crash has occurred prior to the occurrence of the serious crash within the predetermined time period, the airbag ECU 20 automatically transmits data about the passenger information, the vehicle operation information, and the degree of the crash, which have been collected on the recording medium 26 in the predetermined format when the minor crash has occurred, to the emergency report center 14 via the DCM 30 (Step S108).

In response to receiving the report of the occurrence of the serious crash from the in-vehicle apparatus 12 of the vehicle by the receiver 32, the emergency report center 14 has the passenger estimation unit 34 estimate the state of injury of the vehicle passenger(s), based on data about the passenger information, the vehicle operation information, and the degree of the crash from the in-vehicle apparatus 12 when the crash has occurred (Step S110).

Specifically, if the airbag ECU 20 of the in-vehicle apparatus 12 has determined at Step S106 that no minor crash has occurred prior to the occurrence of the serious crash within the predetermined time period, the emergency report center 14 only receives the data generated with the serious crash from the in-vehicle apparatus 12, and hence, estimates the state of the degree of the injury of the passenger(s) of the vehicle, based only on the received data generated with the serious crash. On the other hand, if the airbag ECU 20 of the in-vehicle apparatus 12 has determined at Step S106 that a minor crash has occurred prior to the occurrence of the serious crash within the predetermined time period, the emergency report center 14 not only receives the data generated with the serious crash, but also the data generated with the minor crash prior to the serious crash from the in-vehicle apparatus 12, and hence, estimates the state of the degree of the injury of the passenger(s) of the vehicle, based on both the data generated with the serious crash and the data generated with the minor crash.

Note that the estimation by the passenger estimation unit 34 of the emergency report center 14 may be executed by referring to a database in which a relationship is specified in advance between data about passenger information, vehicle operation information, and the degree of a crash (or a calculated value obtained by calculating a predetermined calculation formula on the data about passenger information, vehicle operation information, and the degree of a crash), and the degree of injury of a passenger(s). Also, this estimation may be executed by referring to either a database in which a relationship is specified in advance between crash forms of serious crashes and the degree of injury of a passenger(s), or another database in which a relationship is specified in advance between crash forms of serious crashes and minor crashes occurred prior to the serious crashes, and the degree of injury of a passenger(s). Namely, the estimation is executed so that different estimation results are obtained for a case where only a serious crash has occurred, and for a case where both a serious crash and a minor crash prior to the serious crash have occurred.

The emergency report center 14 determines whether the degree of the injury of the passenger(s) estimated by the passenger estimation unit 34 is a serious injury (Step S112). Then, depending on the determination result, the emergency report center 14 selects a transport destination for the passenger(s). For example, if determining the degree of the injury of the passenger(s) is not serious, the emergency report center 14 selects an emergency service 16 to give the passenger(s) first-aid measures (for example, a fire department), and sends a report of the occurrence of the traffic accident (Step S114). On the other hand, if determining the degree of the injury of the passenger(s) is serious, the emergency report center 14 selects an emergency service 16 to give the passenger(s) emergent life-saving measures (for example, an emergency and life-saving center), and sends a report of the occurrence of the traffic accident (Step S116). After that, the passenger(s) is transported to a hospital by an ambulance or an air ambulance (Step S118).

In this way, when a crash has occurred to a vehicle, the passenger state estimation system 10 in the present embodiment can record data about the passenger information, the vehicle operation information, and the degree of the crash when the crash has occurred onto the recording medium 26, regardless of whether the crash is a minor crash not requiring airbag deployment or a serious crash requiring airbag deployment.

Also, if the crash has occurred to the vehicle is a serious crash, the passenger state estimation system 10 can deploy an airbag by using the airbag actuator 28, can automatically transmit the data about the passenger information, the vehicle operation information, and the degree of the crash on the occurrence of the serious crash from the in-vehicle apparatus 12 to the emergency report center 14, and can have the emergency report center 14 estimate the state of the degree of the injury of the passenger(s), based on the data automatically transmitted from the in-vehicle apparatus 12.

Furthermore, if the crash that has occurred to the vehicle is a serious crash, and a minor crash has occurred prior to the occurrence of the serious crash within a predetermined time period, the passenger state estimation system 10 can further automatically transmit the data about the passenger information, the vehicle operation information, and the degree of the crash on the occurrence of the minor crash from the in-vehicle apparatus 12 to the emergency report center 14, and can have the emergency report center 14 estimate the state of the degree of the injury of the passenger(s) of the vehicle, based on both the data generated with the serious crash and the data generated with the minor crash prior to the serious crash.

Therefore, according to the passenger state estimation system 10 in the present embodiment, if multiple crashes including a serious crash requiring airbag deployment and a minor crash not requiring airbag deployment have occurred to a vehicle in multiple crashes such as a pileup, data generated with the minor crash, which is not usually automatically transmitted from the in-vehicle apparatus 12 to the emergency report center 14, can be automatically transmitted in addition to data generated with the serious crash. Therefore the emergency report center 14 can finely estimate the state of the degree of injury of a passenger(s).

Namely, data to be used for estimating the state of the degree of injury of a passenger(s) at the emergency report center 14 is not limited to a single serious crash. If a minor crash has occurred prior to the serious crash, data to be used for the state estimation may include data obtained for the minor crash prior to the serious crash in addition to the data obtained for the serious crash. Therefore, according to the present embodiment, the precision can be improved for the state estimation of a passenger(s) when a vehicle crashes, and the state can be correctly estimated. Consequently, selection of an emergency service 16 and protection of the passenger(s) can be appropriately executed.

Note that, in the above embodiment, the sensor 22 corresponds to an “in-vehicle sensor” described in the claims; the airbag ECU 20 determining that a crash has occurred to the vehicle with an obstacle, which ranges from a minor crash to a serious crash, based on data from the sensors 22, corresponds to a “crash determination unit” described in the claims; the airbag ECU 20 executing Step S100 in the routine illustrated in FIG. 2 corresponds to a “recording execution unit” described in the claims; the airbag ECU 20 executing Steps S104 and S108 corresponds to a “transmitter unit” described in the claims; the receiver 32 corresponds to a “receiver unit” described in the claims; the passenger estimation unit 34 corresponds to a “passenger estimation unit” described in the claims; and the emergency report center 14 corresponds to a “center” described in the claims.

Incidentally, in the above embodiment, if a serious crash requiring airbag deployment has occurred to the vehicle, data about the passenger information, the vehicle operation information, and the degree of the crash are used as data to be transmitted from the in-vehicle apparatus 12 to the emergency report center 14. However, the present invention is not limited to this, but the data may include at least one of the passenger information, the vehicle operation information, and the degree of the crash.

Also, in the above embodiment, if a serious crash requiring airbag deployment has occurred to the vehicle, data generated with the crash is transmitted from the in-vehicle apparatus 12 to the emergency report center 14 regardless of the form of the serious crash. However, the present invention is not limited to this, but if multiple serious crashes having forms different from each other have occurred simultaneously, one of the multiple serious crashes may be selected based on the order of influence on the injury value of the passenger(s), and only the data generated with the selected crash may be transmitted from the in-vehicle apparatus 12 to the emergency report center 14.

In this modified example, if the in-vehicle apparatus 12 detects that multiple serious crashes having forms different from each other have occurred, first, the in-vehicle apparatus 12 prioritizes the multiple serious crashes that have occurred, based on the order of influence on the injury value of the passenger(s), which has been predetermined for the crash forms. Next, among the multiple serious crashes that have occurred, the in-vehicle apparatus 12 selects a crash having the greatest influence on the injury value of the passenger(s) in the order, as the serious crash whose data is to be transmitted to the emergency report center 14. Then, the in-vehicle apparatus 12 automatically transmits only the data generated with the selected crash to the emergency report center 14 via the DCM 30. In this case, although multiple serious crashes having forms different from each other have occurred simultaneously, the emergency report center 14 estimates the state of the degree of the injury of the passenger(s) by using the data generated with the crash having the greatest influence on the injury value of the passenger(s), without using data generated with crashes having comparatively less influences on the injury value of the passenger(s), among the multiple serious crashes that have occurred.

Note that when multiple serious crashes having forms different from each other have occurred simultaneously as described above, the in-vehicle apparatus 12 may have the recording medium 26 record all data generated with those crashes, or may have the recording medium 26 record only the data generated with the crash having the greatest influence on the injury value of the passenger(s) among the multiple serious crashes.

Since influences on the injury value of a passenger(s) are different from each other depending on crash forms, this modified example is effective for improving the precision of the passenger state estimation, by providing data generated with a crash form having a higher influence on the injury value of a passenger(s) from the in-vehicle apparatus 12 to the emergency report center 14, and by having the emergency report center 14 execute the state estimation of the passenger(s) with the provided data. Note that the order of crash forms based on influence on the injury value of a passenger(s) is set to, for example, order of “front crash”, “rear crash”, “side crash”, and “roll over”.

Also, in the above embodiment, if a minor crash has occurred to a vehicle, and after that, a serious crash has occurred within a predetermined time period, data generated with the minor crash is automatically transmitted from the in-vehicle apparatus 12 to the emergency report center 14, in addition to data generated with the serious crash. If multiple minor crashes have occurred prior to the occurrence of the serious crash within a predetermined time period, data to be transmitted from the in-vehicle apparatus 12 to the emergency report center 14 may be data generated with the latest minor crash among data generated with respective occurrences of the multiple minor crashes, or data generated with all minor crashes.

Also, if multiple minor crashes have occurred prior to the occurrence of the serious crash within a predetermined time period, among the multiple minor crashes, only data generated with a crash that is selected based on the order of influence on the injury value of a passenger(s), may be transmitted from the in-vehicle apparatus 12 to the emergency report center 14.

In this modified example, if detecting that multiple minor crashes have occurred prior to the occurrence of the serious crash within a predetermined time period, the in-vehicle apparatus 12 first prioritizes the multiple minor crashes that have occurred, based on the order of influence on the injury value of the passenger(s), which has been predetermined for the crash forms. Next, among the multiple minor crashes that have occurred, the in-vehicle apparatus 12 selects a crash having the greatest influence on the injury value of the passenger(s) in the order, as a minor crash whose data is to be transmitted to the emergency report center 14. Then, the in-vehicle apparatus 12 automatically transmits only the data generated with the selected crash among data generated with respective occurrences of the multiple minor crashes, to the emergency report center 14 via the DCM 30. In this case, although the multiple minor crashes have occurred prior to the occurrence of the serious crash within a predetermined time period, the emergency report center 14 estimates the state of the degree of the injury of the passenger(s) by using data generated with the crash having the greatest influence on the injury value of the passenger(s) among the multiple minor crashes that have occurred, without using data generated when crashes having comparatively less influences on the injury value of the passenger(s).

Since influences on the injury value of a passenger(s) are different from each other depending on the crash forms, this modified example is effective for improving the precision of the passenger state estimation, by providing data generated with a crash form having a higher influence on the injury value of a passenger(s) from the in-vehicle apparatus 12 to the emergency report center 14, and by having the emergency report center 14 execute the state estimation of the passenger(s) with the provided data. Note that the order of crash forms based on influence on the injury value of a passenger(s) is set to, for example, order of “front crash”, “rear crash”, “side crash”, and “roll over”.

Also, in the above embodiment, if a serious crash has occurred to the vehicle, the in-vehicle apparatus 12 determines whether a minor crash has occurred to the vehicle prior to the occurrence time of the serious crash within the predetermined time period, and if determining that a minor crash has occurred, automatically transmits data generated with the minor crash to the emergency report center 14. However, the present invention is not limited to this, but if a serious crash has occurred to the vehicle, the in-vehicle apparatus 12 may automatically transmit data generated with crashes to the emergency report center 14, without distinguishing serious or minor crashes that have occurred prior to the serious crash within the predetermined time period. Namely, if determining that crashes including a minor crash have occurred to the vehicle prior to a serious crash within the predetermined time period, the emergency report center 14 may automatically transmit the data generated with the serious crash and the data generated with the crashes including the minor crash that have occurred prior to the serious crash within the predetermined time period.

The present application is based on Japanese Priority Application No. 2014-203354, filed on Oct. 1, 2014, the entire contents of which are hereby incorporated by reference.

1. A passenger state estimation system, comprising:
an in-vehicle apparatus configured to include
a crash determination unit configured to determine whether a crash has occurred to a vehicle having the in-vehicle apparatus installed, by using an in-vehicle sensor,
a recording execution unit configured,
if the crash determination unit determines that a crash has occurred to the vehicle, to have an in-vehicle recording medium record data of at least one of passenger information, vehicle operation information, and a degree of the crash, the data having been generated when the crash occurs, and
a transmitter unit configured to transmit the data externally; and
a center configured to include
a receiver unit configured to receive the data transmitted from the transmitter unit of the vehicle, and
a passenger estimation unit configured to estimate a state of a passenger of the vehicle, based on the data received by the receiver unit,
wherein if the crash determined to have occurred to the vehicle by the crash determination unit is a crash requiring airbag deployment, and crashes including a crash not requiring airbag deployment have been determined to have occurred prior to the crash requiring airbag deployment within a predetermined time period, by the crash determination unit, the transmitter unit transmits the data generated when the crash requiring airbag deployment has occurred, and the data generated when the crashes including the crash not requiring airbag deployment have occurred, to the center,
wherein the passenger estimation unit estimates the state of the passenger of the vehicle, based on the data generated when the crash requiring airbag deployment has occurred, and the data generated when the crashes including the crash not requiring airbag deployment have occurred.

2. The passenger state estimation system, as claimed in claim 1, wherein the in-vehicle apparatus further includes a crash selection unit configured, if a plurality of crashes having forms different from each other have occurred, to select a crash among the crashes, based on order of influence on an injury value of a passenger with the crashes, the data of the selected crash is to be transmitted to the center,
wherein the transmitter unit transmits the data generated when the crash selected by the crash selection unit has occurred, to the center.

3. An in-vehicle apparatus, comprising:
a crash determination unit configured to determine whether a crash has occurred to a vehicle having the in-vehicle apparatus installed, by using an in-vehicle sensor;
a recording execution unit configured, if the crash determination unit determines that a crash has occurred to the vehicle, to have an in-vehicle recording medium record data of at least one of passenger information, vehicle operation information, and a degree of the crash, the data having been generated when the crash occurs; and
a transmitter unit configured to transmit the data to a center,
wherein if the crash determined to have occurred to the vehicle by the crash determination unit is a crash requiring airbag deployment, and crashes including a crash not requiring airbag deployment have been determined to have occurred prior to the crash requiring airbag deployment within a predetermined time period, by the crash determination unit, the transmitter unit transmits the data generated when the crash requiring airbag deployment has occurred, and the data generated when the crashes including the crash not requiring airbag deployment have occurred, to the center.
